(19) United States
(12) Patent Application Publication
(10) Pub. No.: US 2026/0089018 A1
(43) Pub. Date: Mar. 26, 2026

(54) METHOD FOR IMPROVING ABILITY OF STRONG PUF TO RESIST MACHINE LEARNING ATTACKS

(71) Applicant: Wenzhou University, Zhejiang (CN)

(72) Inventors: Gang LI, Zhejiang (CN); Pengjun WANG, Zhejiang (CN); Liangxiao Zhao, Zhejiang (CN); Yijian SHI, Zhejiang (CN)

(73) Assignee: Wenzhou University, Zhejiang (CN)

(21) Appl. No.: 19/026,577

(22) Filed: Jan. 17, 2025

(30) Foreign Application Priority Data
Sep. 24, 2024 (CN) 202411330169.3

(51) Int. Cl. H04L 9/32

(52) U.S. Cl. CPC H04L 9/3278

(57) ABSTRACT

A method for improving ability of strong PUF to resist machine learning attacks. When obfuscating challenge, method comprises: performing conversion on Rubik's cube matrix on basis of current challenge to generate cryptographic matrix, and constructing challenge matrix based on current challenge; determining matrix multiplication pattern of cryptographic matrix and challenge matrix on basis of cryptographic matrix, multiplying cryptographic matrix by challenge matrix to obtain obfuscation matrix, converting elements in obfuscation matrix to 0 or 1 according to parity of elements to obtain cryptographic challenge matrix; extracting elements in cryptographic challenge matrix to form cryptographic challenge, if PUF response generated currently is first PUF response of PUF response sequence, Rubik's cube matrix that generates cryptographic challenge in current obfuscation is randomly generated; if not, Rubik's cube matrix that generates cryptographic challenge in current obfuscation is cryptographic matrix generated by previous obfuscation.

### CROSS-REFERENCE TO RELATED APPLICATION

This application claims the priority benefit of China application serial no. 202411330169.3, filed on Sep. 24, 2024. The entirety of the above-mentioned patent application is hereby incorporated by reference herein and made a part of this specification.

### TECHNICAL FIELD

The present disclosure relates to the field of machine learning attacks resistant strong PUF technology and, in particular, to a method for improving the ability of a strong PUF to resist machine learning attacks.

### BACKGROUND

The physically unclonable function (PUF) takes advantage of the tiny inhomogeneity of the chip manufacturing process to provide a unique identity for each device. With the advantages of low cost, low power consumption and no need for additional storage space, the PUF has a wide range of application prospects in the field of Internet of Things security.

Depending on the number of challenge-response pairs (CRPs) generated, PUFs can be divided into two categories: strong PUFs and weak PUFs. A weak PUF typically generates only a small amount of CRPs, which can be used as a key to an encryption system. A strong PUF can provide a large number of unique CRPs, so that they are suitable for lightweight device authentication. However, current strong PUFs are vulnerable to machine learning attacks, where an attacker can model a PUF by collecting a certain amount of CRPs. Taking an Arbiter PUF (APUF) with 64 challenge bits disclosed in Reference 1 (X Ma, P Wang, G Li, Z Zhou, “Machine Learning Attacks Resistant Strong PUF Design Utilizing Response Obfuscates Challenge with Lower Hardware Overhead” [J]. Microelectronics Journal, vol. 142, 2023.) as an example, when about 1000 CRPs were used for modeling attacks, the prediction accuracy of a training model was higher than 95%; When 10,000 CRPs were used, the prediction accuracy was up to 99%.

In recent years, in order to resist ML modeling attacks, many methods have been proposed to improve the resistance of strong PUFs to machine learning attacks. These methods for improving the resistance of strong PUF to machine learning attacks complicate the mapping relationship between challenge and response by obfuscating challenges and responses, thus preventing attackers from collecting effective CRPs to carry out ML modeling attacks on PUFs. Typical examples may be the XOR-APUF reported in Reference 2 (N. N. Anandakumar, M. S. Hashmi and M. A. Chaudhary, “Implementation of Efficient XOR Arbiter PUF on FPGA With Enhanced Uniqueness and Security” [J]IEEE Access, vol. 10, 2022 pp. 129832-129842.), the MPUF reported in Reference 3 (D. P. Sahoo, D. Mukhopadhyay, R. S. Chakraborty and P. H. Nguyen, “A Multiplexer-Based Arbiter PUF Composition with Enhanced Reliability and Security” [J]IEEE Transactions on Computers, vol. 67, no. 3, 2018, pp. 403-41.) and the iPUF reported in Reference 4 (W. Xu, L. Pang, Y. Tang, and M. Chen, “Security Evaluation of Feed-Forward Interpose PUF Against Modelling Attacks” [C]2024 IEEE 4th International Conference on Power, Electronics and Computer Applications (ICPECA), Shenyang, China, 2024, pp. 871-877.)

However, current methods for improving the ability of a strong PUF to resist machine learning attacks have certain limitations. For the challenge obfuscation, when an obfuscation algorithm and structure are disclosed, the attacker can establish a relationship with the response by obtaining the obfuscated challenges, thus bypassing the obfuscation and directly attacking the strong PUF. For response obfuscation, a final response is obtained by obfuscation of the responses of multiple independent strong PUFs. However, every strong PUF will be affected by a certain amount of noise, usually including temperature changes, voltage changes, etc. When the responses of multiple strong PUFs are obfuscated, the instability of the response of any one strong PUF can lead to the instability of the final response. Consequently, the noise is amplified, resulting in a reduction in the stability of the strong PUF. In addition, for both challenge obfuscation and response obfuscation, the current response is determined by the current challenge, which is similar to the characteristics of combinatorial logic circuits. The complexity of obfuscation is limited, so it is difficult to resist higher-order machine learning attacks.

### SUMMARY

The technical problem to be solved by the present disclosure is to provide a method for improving the ability of a strong PUF to resist machine learning attacks, which has strong anti-machine learning attack resistance and can ensure high stability of the strong PUF.

The technical solution adopted herein to solve the above technical problems is: A method for improving the ability of a strong PUF to resist machine learning attacks, comprising: when a strong PUF needs to generate a PUF response sequence, before generating a PUF response for the PUF response sequence each time, obfuscating the current challenge of the strong PUF to generate a cryptographic challenge, so that the strong PUF generates a PUF response under the action of cryptographic challenge, wherein each cryptographic challenge is generated in the following way: firstly, performing conversion on a Rubik's cube matrix on the basis of the current challenge to generate a cryptographic matrix, and constructing a challenge matrix based on the current challenge; then, determining a matrix multiplication pattern of the cryptographic matrix and the challenge matrix on the basis of the cryptographic matrix, multiplying the cryptographic matrix by the challenge matrix to obtain an obfuscation matrix, converting elements in the obfuscation matrix to 0 or 1 according to the parity of the elements to obtain a cryptographic challenge matrix; and finally extracting elements in the cryptographic challenge matrix to form the cryptographic challenge, wherein if the PUF response generated currently is the first PUF response of the PUF response sequence, the Rubik's cube matrix that generates the cryptographic challenge in the current obfuscation is randomly generated; if the PUF response generated currently is not the first PUF response of the PUF response sequence, the Rubik's cube matrix that generates the cryptographic challenge in the current obfuscation is a cryptographic matrix generated by a previous obfuscation.

The method for improving the ability of a strong PUF to resist machine learning attacks comprises the following steps:
step 1, when the strong PUF needs to generate the PUF response sequence, firstly generating six 8*8 Rubik's cube matrices for challenge obfuscation on a computer side, wherein Rubik's cube matrix i is denoted as Mᵢ (i=1, 2, 3, 4, 5, 6), each element in the Mᵢ is 0 or 1, and an element in a column j and row p in the Mᵢ is denoted as

$${k}_{j , p}^{i} ( j = 1 , 2 , 3 , 4 , 5 , 6 , 7 , 8 , p = 1 , 2 , 3 , 4 , 5 , 6 , 7 , 8 ) ;$$

and then starting a challenge obfuscation;
step 2, randomly generating on the computer side a 64-bit challenge C {c₀, c₁ . . . c₆₃}, i.e., the current challenge, calculating the Hamming weight of c₀ to c₄ in the challenge C, and denoting the Hamming weight as n;
step 3, selecting a Rubik's cube matrix Mₙ₊₁ from the computer side and determining the rotation direction of Mᵢ according to an element

$${k}_{1 , i}^{n + 1}$$

in Mₙ₊₁; if

$${k}_{1 , i}^{n + 1}$$

is equal to 0, rotating Mᵢ 90 degrees clockwise; if

$${k}_{1 , i}^{n + 1}$$

is equal to 1, rotating Mᵢ 90 degrees counterclockwise, wherein a matrix obtained after rotating Mᵢ is called a cryptographic matrix thereof, denoted as Mᵢ′, and an element in column j and row p in the cryptographic matrix Mᵢ′ is denoted as

$${k}_{j , p}^{i ′} ;$$

step 4, generating a challenge matrix on the computer side according to the current challenge, wherein an element in column j and row p in the challenge matrix is c_{(j-1)*8+(p-1)}; determining whether

$${k}_{1 , 1}^{n + 1 ′}$$

in Mₙ₊₁′ is 0; if

$${k}_{1 , 1}^{n + 1 ′}$$

is 0, premultiplying Mₙ₊₁′ by the challenge matrix; if

$${k}_{1 , 1}^{n + 1 ′}$$

is not 0, then post-multiplying Mₙ₊₁′ by the challemge matrix, thus obtaining an obfuscation matrix, denoted as H;
step 5, converting the obfuscation matrix H on the computer side to obtain a cryptographic challenge matrix H′; specifically: determining parity of each element in the obfuscation matrix H separately; if an element is odd, updating the value of the element to equal to 1, otherwise updating the value of the element to equal to 0;
step 6, on the computer side, sequentially taking out the elements of each column in the cryptographic challenge matrix H′ according to the order of the first to the eighth column and the order of the first to the eighth row and arranging the elements from high bit to low bit to form 64-bit data which is a cryptographic challenge, denoted as C′, thus completing a challenge obfuscation;
step 7, on the computer side, inputting the cryptographic challenge C′ obtained by the current challenge obfuscation into the strong PUF as a challenge signal of the strong PUF, and then allowing the strong PUF to generate a PUF response output for the PUF response sequence; and
step 8, on the computer side, updating the Rubik's cube matrix Mᵢ to equal to the cryptographic matrix

$${M}_{i}^{′}$$

obtained by the current challenge obfuscation, and then returning to step 2 for next challenge obfuscation until the strong PUF produces a desired PUF response sequence.

Compared with the prior art, the present disclosure has the advantage that each cryptographic challenge is generated in the following way: firstly, performing conversion on a Rubik's cube matrix on the basis of the current challenge to generate a cryptographic matrix, and constructing a challenge matrix based on the current challenge; then, determining a matrix multiplication pattern of the cryptographic matrix and the challenge matrix on the basis of the cryptographic matrix, multiplying the cryptographic matrix by the challenge matrix to obtain an obfuscation matrix, converting elements in the obfuscation matrix to 0 or 1 according to the parity of the elements to obtain a cryptographic challenge matrix; and finally extracting elements in the cryptographic challenge matrix to form the cryptographic challenge, wherein if the PUF response generated currently is the first PUF response of the PUF response sequence, the Rubik's cube matrix that generates the cryptographic challenge in the current obfuscation is randomly generated; if the PUF response generated currently is not the first PUF response of the PUF response sequence, the Rubik's cube matrix that generates the cryptographic challenge in the current obfuscation is a cryptographic matrix generated by a previous obfuscation. In view of this, only the challenges of the strong PUF are obfuscated. The obfuscation process does not involve such PUF responses output by the strong PUF that may be affected by noise. So the challenge confusion process is stable and reliable, and it will not be affected by noise and will not cause adverse effects on the stability of the strong PUF, thereby ensuring high stability of the strong PUF. Moreover, since the accuracy of machine learning attack modeling is related to the complexity of the mapping relationship between challenges and responses, and the more complex the mapping relationship is, the lower the modeling accuracy is. The present disclosure adopts a sequential logic-like obfuscation method in which the cryptographic matrix generated by the previous obfuscation is used as the Rubik's cube matrix in the next obfuscation, so the current PUF response of the strong PUF is not only dependent on the current challenge, but also related to the previous challenge. In addition, the matrix multiplication method is adopted in the obfuscation process to increase the complexity of the mapping relationship between challenges and responses. Therefore, the present disclosure can effectively resist machine learning attacks and has excellent resistance to machine learning attacks.

### BRIEF DESCRIPTION OF THE DRAWINGS

FIG. 1 is a flow chart of a method for improving the ability of a strong PUF to resist machine learning attacks according to the present disclosure;

FIG. 2A shows the prediction rates (FPGA) of logistic regression attack resistance of an APUF with challenge obfuscation based on the method for improving the ability of a strong PUF to resist machine learning attacks according to the present disclosure and several common strong PUFs;

FIG. 2B shows the prediction rates (FPGA) of light gradient boosting machine attack resistance of an APUF with challenge obfuscation based on the method for improving the ability of a strong PUF to resist machine learning attacks according to the present disclosure and several common strong PUFs;

FIG. 2C shows the prediction rates (FPGA) of support vector machine attack resistance of an APUF with challenge obfuscation based on the method for improving the ability of a strong PUF to resist machine learning attacks according to the present disclosure and several common strong PUFs;

FIG. 2D shows the prediction rates (FPGA) of artificial neural network attack resistance of an APUF with challenge obfuscation based on the method for improving the ability of a strong PUF to resist machine learning attacks according to the present disclosure and several common strong PUFs;

FIG. 3 shows statistical distribution of inter-chip Hamming distance and intra-chip Hamming distance between PUF responses output by a strong PUF using the method for improving the ability of a strong PUF to resist machine learning attacks according to the present disclosure.

### DESCRIPTION OF THE EMBODIMENTS

The present disclosure is further described below in conjunction with accompanying drawings and embodiments.

Embodiment 1: A method for improving the ability of a strong PUF to resist machine learning attacks comprises: when a strong PUF needs to generate a PUF response sequence, before generating a PUF response for the PUF response sequence each time, obfuscating the current challenge of the strong PUF to generate a cryptographic challenge, so that the strong PUF generates a PUF response under the action of cryptographic challenge, wherein each cryptographic challenge is generated in the following way: firstly, performing conversion on a Rubik's cube matrix on the basis of the current challenge to generate a cryptographic matrix, and constructing a challenge matrix based on the current challenge; then, determining a matrix multiplication pattern of the cryptographic matrix and the challenge matrix on the basis of the cryptographic matrix, multiplying the cryptographic matrix by the challenge matrix to obtain an obfuscation matrix, converting elements in the obfuscation matrix to 0 or 1 according to the parity of the elements to obtain a cryptographic challenge matrix; and finally extracting elements in the cryptographic challenge matrix to form the cryptographic challenge, wherein if the PUF response generated currently is the first PUF response of the PUF response sequence, the Rubik's cube matrix that generates the cryptographic challenge in the current obfuscation is randomly generated; if the PUF response generated currently is not the first PUF response of the PUF response sequence, the Rubik's cube matrix that generates the cryptographic challenge in the current obfuscation is a cryptographic matrix generated by a previous obfuscation.

In this embodiment, during the challenge obfuscation, only the challenges of the strong PUF are obfuscated. The obfuscation process does not involve such PUF responses output by the strong PUF that may be affected by noise. So the challenge confusion process is stable and reliable, and it will not be affected by noise and will not cause adverse effects on the stability of the strong PUF, thereby ensuring high stability of the strong PUF. Moreover, since the accuracy of machine learning attack modeling is related to the complexity of the mapping relationship between challenges and responses, and the more complex the mapping relationship is, the lower the modeling accuracy is. The present disclosure adopts a sequential logic-like obfuscation method in which the Rubik's cube matrix in the next obfuscation is updated to equal to the cryptographic matrix produced by the previous obfuscation, so the current PUF response of the strong PUF is not only dependent on the current challenge, but also related to the previous challenge. In addition, the matrix multiplication method is adopted in the obfuscation process to increase the complexity of the mapping relationship between challenges and responses. Therefore, the present disclosure can effectively resist machine learning attacks and has excellent resistance to machine learning attacks.

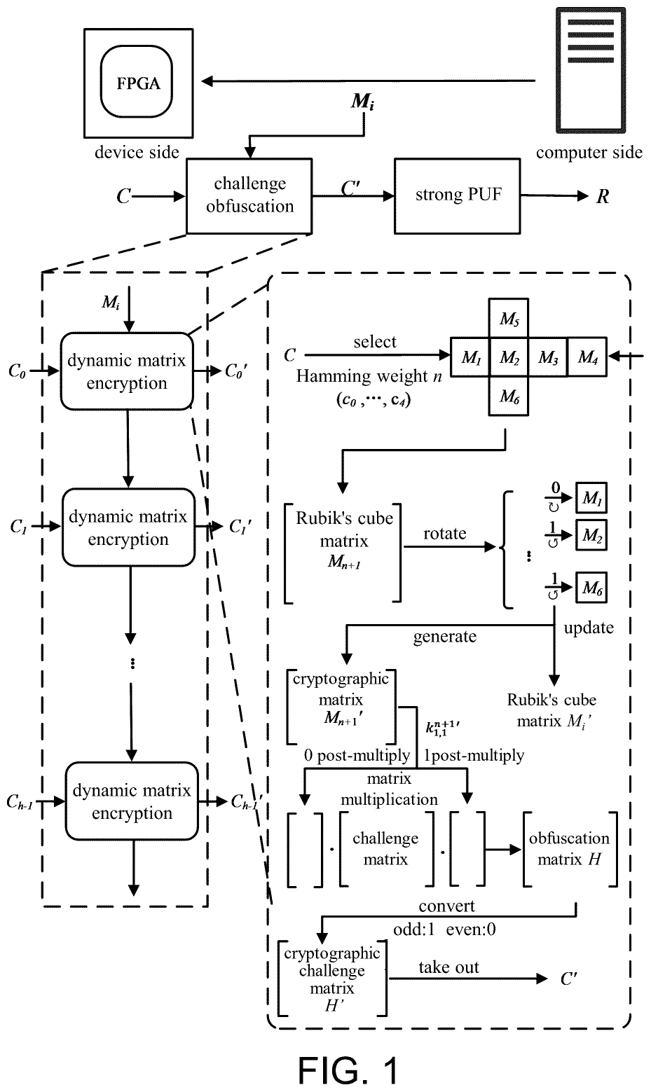

Embodiment 2: As shown in FIG. 1, a method for improving the ability of a strong PUF to resist machine learning attacks comprises the following steps:
Step 1, when the strong PUF needs to generate the PUF response sequence, firstly generating six 8*8 Rubik's cube matrices for challenge obfuscation on a computer side, wherein Rubik's cube matrix i is denoted as Mᵢ (i=1,2,3,4,5,6), each element in the Mᵢ is 0 or 1, and an element in the column j and row p in the Mᵢ is denoted as

$${k}_{j , p}^{i} ( j = 1 , 2 , 3 , 4 , 5 , 6 , 7 , 8 , p = 1 , 2 , 3 , 4 , 5 , 6 , 7 , 8 ) ;$$

and then starting a challenge obfuscation;
step 2, randomly generating on the computer side a 64-bit challenge C{c₀, c₁ . . . c₆₃}, i.e., the current challenge, calculating the Hamming weight of c₀ to c₄ in the challenge C, and denoting the Hamming weight as n;
step 3, selecting a Rubik's cube matrix Mₙ₊₁ from the computer side and determining the rotation direction of Mᵢ according to an element

$${k}_{1 , i}^{n + 1}$$

in Mₙ₊₁; if

$${k}_{1 , i}^{n + 1}$$

is equal to 0, rotating Mᵢ 90 degrees clockwise; if

$${k}_{1 , i}^{n + 1}$$

is equal to 1, rotating Mᵢ 90 degrees counterclockwise, wherein a matrix obtained after rotating Mᵢ is called a cryptographic matrix thereof, denoted as

$${M}_{i}^{′} ,$$

and all element in column j and row p in the cryptographic matrix

$${M}_{i}^{′}$$

is denoted as

$${k}_{j , p}^{i ′} ;$$

step 4, generating a challenge matrix on the computer side according to the current challenge, wherein an element in column j and row p in the challenge matrix is c_{(j-1)*8+(p-1)}; determining whether

$${k}_{1 , 1}^{n + 1 ′}$$

is Mₙ₊₁′ is 0, if

$${k}_{1 , 1}^{n + 1 ′}$$

is 0, premultiplying Mₙ₊₁′ by the challenge matrix; if

$${k}_{1 , 1}^{n + 1 ′}$$

is not 0, then post-multiplying Mₙ₊₁′ by the challenge matrix, thus obtaining an obfuscation matrix, denoted as H;
step 5, converting the obfuscation matrix H on the computer side to obtain a cryptographic challenge matrix H′; specifically: determining parity of each element in the obfuscation matrix H separately; if an element is odd, updating the value of the element to equal to 1, otherwise updating the value of the element to equal to 0;
step 6, on the computer side, sequentially taking out the elements of each column in the cryptographic challenge matrix H′ according to the order of the first to the eighth column and the order of the first to the eighth row and arranging the elements from high bit to low bit to form 64-bit data which is a cryptographic challenge, denoted as C′, thus completing a challenge obfuscation;
step 7, on the computer side, inputting the cryptographic challenge C′ obtained by the current challenge obfuscation into the strong PUF as a challenge signal of the strong PUF, and then allowing the strong PUF to generate a PUF response output for the PUF response sequence; and
step 8, on the computer side, updating the Rubik's cube matrix Mᵢ to equal to the cryptographic matrix

$${M}_{i}^{′}$$

obtained by the current challenge obfuscation, and then returning to step 2 for next challenge obfuscation until the strong PUF produces a desired PUF response sequence.

In order to verify the performance of the method for improving the ability of a strong PUF to resist machine learning attacks according to the present disclosure, logistic regression attack, light gradient boosting machine attack, and support vector machine attack are used to compare and verify the performance of the APUF with challenge obfuscation based on the method for improving the resistance of the strong PUF against machine learning attacks in Embodiment 2 and several common strong PUFs.

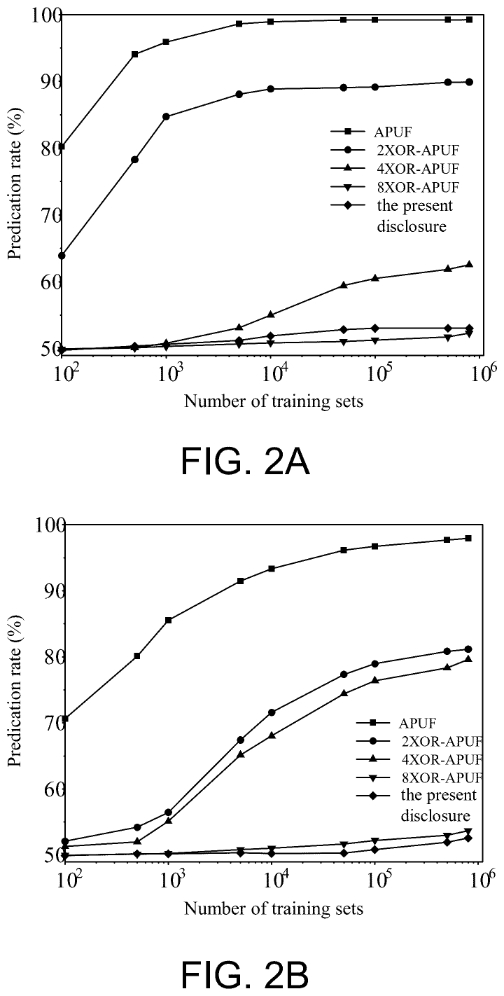

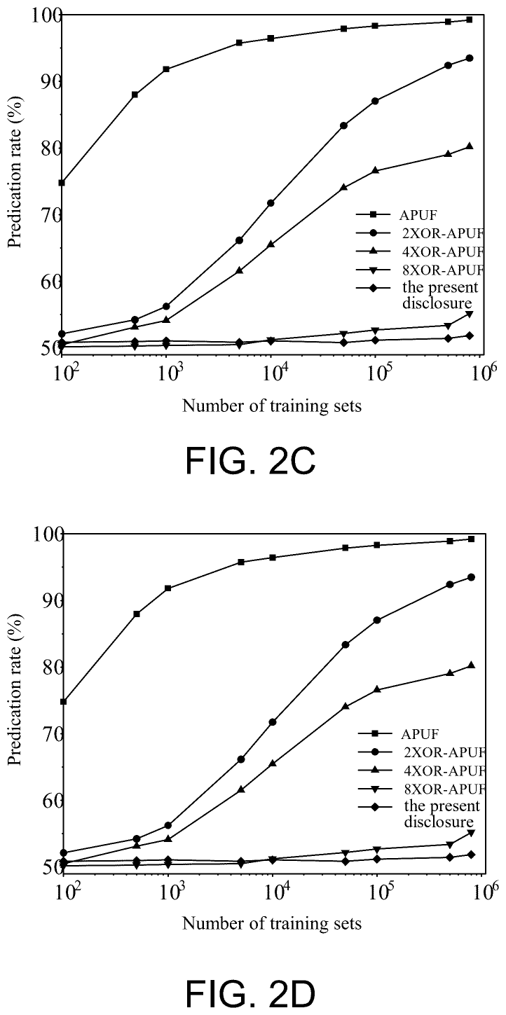

FIGS. 2A to 2D show the prediction rates of an APUF, a 2XOR-APUF, a 4XOR-APUF, an 8XOR-APUF and an APUF with challenge obfuscation based on the method for improving the ability of a strong PUF to resist machine learning attacks according to the present disclosure under four types of machine learning attacks. Referring to FIGS. 2A to 2D, the APUF with challenge obfuscation based on the method for improving the ability of a strong PUF to resist machine learning attacks according to the present disclosure has better machine learning attack resistance than the conventional APUF, 2XOR-APUF, 4XOR-APUF and 8XOR-APUF, and the attack results show that, when the number of CRPs is up to 1 million, the prediction rates under the four types of machine learning attacks are all around 50%, which is close to the ideal performance. Therefore, the method for improving the ability of a strong PUF to resist machine learning attacks has good machine learning attack resistance.

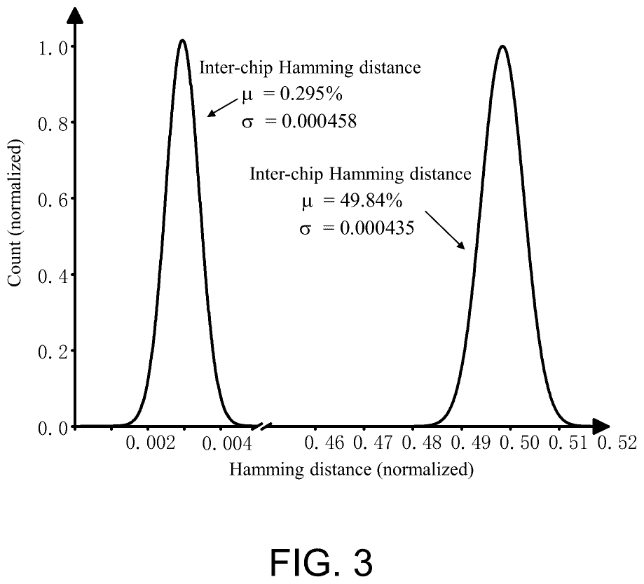

FIG. 3 shows the statistical distribution of the inter-chip Hamming distance and the intra-chip Hamming distance between the responses output by a strong PUF for challenge obfuscation based on the method for improving the ability of a strong PUF to resist machine learning attacks according to the present disclosure, where a total of 50 groups of CRPs with a quantity of 2000 were collected at intra-chip Hamming distance, and the challenges of each group were maintained constant; and a total of 50 groups of CRPs with a quantity of 2000 were collected at inter-chip Hamming distance, the challenges of each group were maintained constant, and each group used different strong PUFs of the same type. The mean value and standard deviation of the inter-chip Hamming distance are 49.84% and 0.000435, respectively, which are close to the ideal values of 50% and 0, indicating that the strong PUF using the method for improving the ability of a strong PUF to resist machine learning attacks according to the present disclosure has good uniqueness. The mean value and standard deviation of the intra-chip Hamming distance are 0.295% and 0.000458 respectively, which are close to the ideal value 0, indicating that the strong PUF using the method for improving the ability of a strong PUF to resist machine learning attacks according to the present disclosure has high reliability.

The NIST randomness test is conducted on the conventional APUF and the APUF with challenge obfuscation based on the method for improving the ability of a strong PUF to resist machine learning attacks in Embodiment 2 of the present disclosure. The test data are shown in Table 1:

TABLE 1

| | | | APUF with challenge | |
|---|---|---|---|---|
| | | | obfuscation based | |
| | Conventional | | on the method of the | |
| | APUF | | present disclosure | |
| | | Propor- | | Propor- |
| Statistical test | P-value | tion | P-value | tion |
| Frequency | 0.000000* | 1/50 | 0.043524 | 50/50 |
| BlockFrequency | 0.000000* | 42/50 | 0.213309 | 50/50 |
| CumulativeSums-1 | 0.000000* | 2/50 | 0.000000* | 5/50 |
| CumulativeSums-2 | 0.000000* | 3/50 | 0.000000* | 2/50 |
| Runs | 0.000000* | 13/50 | 0.054199 | 50/50 |
| LongestRun | 0.000000* | 39/50 | 0.671779 | 50/50 |
| Rank | 0.779188 | 50/50 | 0.023117 | 50/50 |
| FFT | 0.534146 | 49/50 | 0.862344 | 50/50 |
| NonOverlappingTemplate | Not Pass | | Not Pass | |
| OverlappingTemplate | 0.153763 | 47/50 | 0.468595 | 49/50 |
| Universal | 0.000000* | 50/50 | 0.000000* | 50/50 |
| ApproximateEntropy | 0.000000* | 44/50 | 0.000000* | 45/50 |
| Serial-1 | 0.319084 | 49/50 | 0.122325 | 50/50 |
| Serial-2 | 0.816537 | 50/50 | 0.534146 | 50/50 |
| LinearComplexity | 0.289667 | 49/50 | 0.949602 | 49/50 |

Table 1 shows the randomness test suite (SP800-22) provided by the National Institute of Standards and Technology (NIST). NIST consists of 15 tests, and whether or not each test passes is determined by the relationship between a p-value and a pre-set test significance level: specifying a p-value ≥α indicates that the sequence is random, and vice versa. It is generally recommended to set the value to 0.01, and the range of P-value is [0, 1]. In the experiment, one million challenges randomly generated were applied to a conventional APUF and the APUF with challenge obfuscation based on the method for improving the ability of a strong PUF to resist machine learning attacks according to the present disclosure to generate one million responses, which were divided into 50 groups (20,000 in each group) for NIST testing.

Referring to Table 1, the APUF with challenge obfuscation based on the method for improving the ability of a strong PUF to resist machine learning attacks according to the present disclosure passes 10 random number tests, while the conventional APUF passes 6 tests, indicating that the method for improving the ability of a strong PUF to resist machine learning attacks according to the present disclosure can improve the randomness of the strong PUF.

The performance of the APUF with challenge obfuscation based on the method for improving the ability of a strong PUF to resist machine learning attacks according to the present disclosure is compared with that of the conventional strong PUF. The comparison data are shown in Table 2:

TABLE 2

| | Machine learning prediction rate (%) | | | | | | |
|---|---|---|---|---|---|---|---|
| | | Light | Support | Artificial | | | |
| | Logistic | gradient | vector | neural | | | |
| Type | regression | boosting | machine | network | Randomness | Uniqueness | Stability |
| APUF | 99.24 | 97.94 | 99.22 | 99.08 | 50.12 | 50.05 | 99.89 |
| 8XOR-APUF | 52.31 | 53.69 | 55.21 | 89.27 | 49.95 | 50.36 | 90.67 |
| (2,1)-MPUF | 70.52 | 80.37 | 91.51 | 97.49 | 50.56 | 50.23 | 97.25 |
| (3,3)-iPUF | 55.59 | 60.53 | 62.09 | 93.42 | 50.87 | 50.15 | 91.06 |
| APUF obfuscated | 52.57 | 51.83 | 51.11 | 52.76 | 50.05 | 49.84 | 99.71 |
| by the method of | | | | | | | |
| the present | | | | | | | |
| disclosure | | | | | | | |

In Table 2, a (2,1)-MPUF is 2-to-1 MPUF, which consists of 3 APUFs and a 2-to-1 path selector, wherein the outputs of two APUFs are the two input signals of the 2-to-1 path selector, and the output of one APUF is the selection signal of the 2-to-1 path selector. A (3,3)-iPUF consists of two different 3XOR-APUFs, one of which is a level 64 3XOR-APUF and the other is a level 65 3XOR-APUF. The output of the level 64 3XOR-APUF is inserted into the middle of the 64-bit challenge to generate a new 65-bit challenge to act on the level 65 3XOR-APUF to obtain a final response.

Referring to Table 2, the prediction rates of the APUF with challenge obfuscation based on the method for improving the ability of a strong PUF to resist machine learning attacks according to the present disclosure under four types of machine learning attacks are all lower than those of other conventional strong PUFs, and all are about 50%, and is about 50%, and its randomness, uniqueness and stability are close to ideal values, indicating that the method for improving the ability of a strong PUF to resist machine learning attacks according to the present disclosure has good performance.

Due to its enhanced security and stability, the method for improving the ability of strong PUF to resist machine learning attacks according to the present disclosure can be applied to a variety of hardware security fields, such as the following specific application scenarios:
1. IoT device authentication: In IoT devices, each device can generate a unique “fingerprint” by the strong PUF technology for device authentication, ensuring that the device connected to the network is authorized.
2. Smart card security enhancement: In smart cards, strong PUFs can be used to store encryption keys, and only the correct key can access the data in the cards, thus preventing unauthorized reading and copying.
3. Key protection in a hardware security module (HSM): the HSM is used to perform encryption operations and key management, and strong PUF technology can provide hardware-level key protection to ensure the safe storage and use of keys.
4. Transaction security in mobile payment devices: In mobile payment devices, strong PUFs can be used to generate one-time passwords or dynamic tokens to enhance the security of transactions and prevent payment fraud.
5. Data protection in the cloud computing environment: In the cloud computing environment, strong PUFs can be used to generate and protect encryption keys to ensure the security of data stored in the cloud and prevent data leaks.
6. Cyber security of industrial control systems: In industrial control systems, strong PUFs technology can be used to ensure the physical and cyber security of the system and prevent potential cyber attacks and intrusions.
7. Burglar protection of automotive electronic systems: In automotive electronic systems, strong PUFs can be used to generate unique keys to protect vehicles from hackers and illegal starts.
8. Copyright protection in digital rights management (DRM): In DRM, strong PUFs can be used to protect digital content, ensure that the copyright of the content is respected, and prevent illegal copying and distribution.
9. Anti-counterfeiting in biometric systems: In biometric systems, strong PUFs can be used to generate and verify biometric data, improve the security of the system, and prevent forgery and deception.
10. Transaction verification in blockchain technology: In blockchain technology, strong PUFs can be used to generate unique transaction signatures, ensuring the immutability and security of transactions.

In summary, the method for improving the ability of a strong PUF to resist machine learning attacks according to the present disclosure has strong machine learning attack resistance, and can ensure that the strong PUF has high stability and has a wide application prospect in the field of strong PUF security application.

What is claimed is:

1. A method for improving an ability of a strong PUF (physically unclonable function) to resist machine learning attacks, comprising: when a strong PUF needs to generate a PUF response sequence, before generating a PUF response for the PUF response sequence each time, obfuscating a current challenge of the strong PUF to generate a cryptographic challenge, so that the strong PUF generates the PUF response under an action of cryptographic challenge, wherein each cryptographic challenge is generated in following way: firstly, performing conversion on a Rubik's cube matrix on a basis of the current challenge to generate a cryptographic matrix, and constructing a challenge matrix based on the current challenge; then, determining a matrix multiplication pattern of the cryptographic matrix and the challenge matrix on the basis of the cryptographic matrix, multiplying the cryptographic matrix by the challenge matrix to obtain an obfuscation matrix, converting elements in the obfuscation matrix to 0 or 1 according to a parity of the elements to obtain a cryptographic challenge matrix; and finally extracting the elements in the cryptographic challenge matrix to form the cryptographic challenge, wherein if the PUF response generated currently is the first PUF response of the PUF response sequence, the Rubik's cube matrix that generates the cryptographic challenge in the current obfuscation is randomly generated; if the PUF response generated currently is not the first PUF response of the PUF response sequence, the Rubik's cube matrix that generates the cryptographic challenge in the current obfuscation is a cryptographic matrix generated by a previous obfuscation.

2. The method for improving the ability of the strong PUF to resist machine learning attacks according to claim 1, comprises the following steps:
step 1, when the strong PUF needs to generate the PUF response sequence, firstly generating six 8*8 Rubik's cube matrices for challenge obfuscation on a computer side, wherein Rubik's cube matrix i is denoted as Mᵢ (i=1, 2, 3, 4, 5, 6), each element in the Mᵢ is 0 or 1, and an element in a column j and row p in the Mᵢ is denoted as
$${k}_{j , p}^{i} ( j = 1 , 2 , 3 , 4 , 5 , 6 , 7 , 8 , p = 1 , 2 , 3 , 4 , 5 , 6 , 7 , 8 ) ;$$
and then starting the challenge obfuscation;
step 2, randomly generating on the computer side a 64-bit challenge C {c₀, c₁ . . . c₆₃}, i.e., the current challenge, calculating a Hamming weight of c₀ to c₄ in the challenge C, and denoting the Hamming weight as n;
step 3, selecting the Rubik's cube matrix Mₙ₊₁ from the computer side and determining a rotation direction of Mᵢ according to an element
$${k}_{1 , i}^{n + 1}$$
in Mₙ₊₁; if
$${k}_{1 , i}^{n + 1}$$
equal to 0, rotating Mᵢ 90 degrees clockwise; if
$${k}_{1 , i}^{n + 1}$$
is equal to 1, Mᵢ 90 degrees counterclockwise, wherein a matrix obtained after rotating Mᵢ is called the cryptographic matrix there, denoted as
$${M}_{i}^{′} ,$$
and an element in column j and row p in the cryptographic matrix Mᵢ′ is denoted as
$${k}_{j , p}^{i ′} ;$$
step 4, generating the challenge matrix on the computer side according to the current challenge, wherein an element in column j and row p in the challenge matrix is c_{(j-1)*8+(p-1)}; determining whether
$${k}_{1 , 1}^{n + 1 ′}$$
in Mₙ₊₁′ is 0; if
$${k}_{1 , 1}^{n + 1 ′}$$
is 0, premultiplying Mₙ₊₁′ by the challenge matrix; if
$${k}_{1 , 1}^{n + 1 ′}$$
is not 0, then post-multiplying Mₙ₊₁′ by the challenge matrix, thus obtaining the obfuscation matrix, denoted as H;
step 5, converting the obfuscation matrix H on the computer side to obtain the cryptographic challenge matrix H′; specifically: determining the parity of each element in the obfuscation matrix H separately; if an element is odd, updating a value of the element to equal to 1, otherwise updating the value of the element to equal to 0;
step 6, on the computer side, sequentially taking out the elements of each column in the cryptographic challenge matrix H′ according to the order of the first to the eighth column and the order of the first to the eighth row and arranging the elements from high bit to low bit to form 64-bit data which is the cryptographic challenge, denoted as C′, thus completing the challenge obfuscation;
step 7, on the computer side, inputting the cryptographic challenge C′ obtained by the current challenge obfuscation into the strong PUF as a challenge signal of the strong PUF, and then allowing the strong PUF to generate a PUF response output for the PUF response sequence; and
step 8, on the computer side, updating the Rubik's cube matrix Mᵢ to equal to the cryptographic matrix
$${M}_{i}^{′}$$
obtained by the current challenge obfuscation, and then returning to step 2 for next challenge obfuscation until the strong PUF produces a desired PUF response sequence.
